(19) United States
(12) Patent Application Publication
(10) Pub. No.: US 2008/0158588 A1
(43) Pub. Date: Jul. 3, 2008

(54) Method and system for generating copy detection pattern having a fixed component and dynamic component

(75) Inventors: Bertrand Haas, New Haven, CT (US); Steven J. Pauly, New Milford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/646,023

(22) Filed: Dec. 27, 2006

(51) Int. Cl. G06F 15/00; G06Q 50/00

(52) U.S. Cl. 358/1.15; 705/408

(57) ABSTRACT

Apparatus and method of creating and printing a postal indicium incorporating a copy detection pattern (CDP) having one or more static portions, an optional semi-static portion, and one or more dynamic portions, including retrieving a previously generated static portion that is stored in a printing device, generating a dynamic portion in the printing device, combining the static and dynamic portions in the printing device to create the CDP, and printing the CDP using the printing device.

### FIELD OF THE INVENTION

The present invention relates to fraud prevention and in particular to a method of generating a copy detection pattern having both a static portion and a dynamic portion for incorporation into a postal indicium to discourage forgery.

### BACKGROUND OF THE INVENTION

The postal services of many countries around the world permit and/or require the printing of evidence of postage payment, such as a postal indicium, that includes a two-dimensional barcode. For example, the United States Postal Service has implemented a program known as the Information Based Indicia Program (IBIP) which permits a user to generate a postage indicium for sending a mailpiece (e.g., letter, package, etc.) that includes a human readable portion and a machine readable portion in the form of a two-dimensional barcode, such as without limitation, what is commonly referred to as a Data Matrix symbol. Such an indicium is commonly referred to as a Digital Postage Mark (DPM). In addition to encoding the value of the postage represented by such an indicium, the two-dimensional barcode may encode other pieces of information concerning the mailpiece and/or the indicium, such as the date on which the indicium was printed, data concerning a characteristic and/or unique identifier of the printer used to print the indicium, an identifier of the sender and/or intended recipient, data concerning the location of the sender and/or intended recipient, an identifier that is assigned and is unique to each mailpiece, the weight of the mailpiece, and/or data concerning the size of the mailpiece.

Because such a postal indicium with such a barcode represents monetary value, and is thus a type of currency, it is tempting for fraudsters to copy a valid postal indicium having such a barcode and reuse it on other mailpieces. Even if a system of detection of duplicates is in place at the postal facilities (such as a system recording the barcodes going through and matching them against a database of all previously recorded barcodes), a number of ways of avoiding detection are possible. For example, the fraudster could send the illegitimate copy of the barcode first and the legitimate barcode afterward, making prosecution practically impossible. Alternatively, in larger countries where billions or mailpieces are processed each year from many different locations around each country, the fraudster could send all copies of the barcode at the same time from different locations so that the copies would be processed before a central database used for detection of duplicates is updated. Thus, it is desirable to protect such a postal indicium against copying.

One possible way to protect a postal indicium against copying would be to incorporate a copy detection pattern (CDP) therein. A highly desirable form of CDP is a dynamic CDP. Such a CDP is dynamic in that the content of the CDP, itself, is dependent upon data that is expected to change frequently, and perhaps as frequently as each time the CDP is incorporated into a postal indicium. On one hand, such a dynamic CDP can be generated in the printing device. Unfortunately, considerable processing capability is needed to generate such a CDP. On the other hand, such a dynamic CDP can be generated by a server with greater computing capability and then transmitted to the printer together with the data to be later incorporated into the indicium. However, this system requires considerable amounts of data to be transmitted (and therefore slows down considerably the required transmission time), and it requires a considerable amount of memory in the printing device to store the CDPs.

The processing and data storage capabilities typically built into printers utilized to print postal indicia, however, are usually limited, typically by a need to produce such a printer at a minimal cost, and therefore are not suitable for incorporating dynamic CDPs therein. While the use of a fixed CDP, i.e., a CDP in which the content of the CDP, itself, is static and does not change such that the identical CDP is repeatedly used, may provide some security when used in postal indicia, while accommodating the limited processing and data storage capabilities of typical printers used to print postal indicia, the security of such a fixed CDP may not be sufficient. For example, improvements made in photocopying, image processing, printing and scanning equipment over time has made it easier to commit fraud by copying and reusing postal indicia, including postal indicia incorporating a fixed CDP. It would be desirable, therefore, to be able to provide dynamic copy detection patterns in postal indicia without having to significantly increase the processing and data storage capabilities built into printers that print such postal indicia and without having to significantly increase the amount of data to be transmitted to such printer.

### SUMMARY OF THE INVENTION

The present invention provides methods and systems for providing security against fraudulent use of postal indicia by incorporating a static/dynamic copy detection pattern in postal indicia. In one embodiment, the invention provides a method of creating and printing a postal indicium incorporating a CDP having both a static portion and a dynamic portion, including storing one or more static portions in a storage of a printing device, generating the dynamic portion on the printing device, combining the static portion and the dynamic portion on the printing device to create the CDP, and printing the postal indicium including the CDP.

The method may further include combining the static portions and the dynamic portions by interspersing pixels of the static portions with pixels of the dynamic portions.

In another embodiment, the invention provides a printing device to print a postal indicium incorporating a CDP having one or more static portions and dynamic portions, including a print engine; a storage having stored therein a CDP generator software; and a processor structured to store the static portions and optionally dynamic portions in the storage, generate one or more dynamic portions, combine the static portions and the dynamic portions to create the CDP, and print the postal indicium.

In another embodiment, the invention provides a machine-readable medium on which a sequence of instructions are stored that when executed by a processor causes the processor to perform operations including generating a static portion of a CDP, and enabling a printing device to create the CDP from the static portion and a dynamic portion generated by the printing device by transmitting the static portion to the printing device.

In another embodiment, the invention provides a machine-readable medium on which a sequence of instructions are stored that when executed by a processor of a printing device causes the processor to perform operations including storing a static portion of a CDP, generating a dynamic portion of the CDP, combining the static portion and the dynamic portion to create the CDP, and printing a postal indicium incorporating the CDP.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates an exemplary pair of devices to create and print a postal indicium;

FIG. 2 illustrates an exemplary postal indicium created by the exemplary pair of devices of FIG. 1;

FIGS. 3, 4A and 4B illustrate an exemplary combination of static and dynamic portions to generate a CDP;

FIG. 5 is a flowchart illustrating an embodiment of processing performed for creating a postal indicium;

FIG. 6 is a flowchart illustrating an embodiment of a method of creating and printing a postal indicium;

FIG. 7 illustrates a second exemplary pair of devices to create and print a postal indicium;

FIG. 8 is a flowchart illustrating another embodiment of a method of creating and printing a postal indicium; and

FIG. 9 illustrates an exemplary combination of static, semi-static and dynamic portions to generate a CDP.

### DESCRIPTION OF THE PREFERRED EMBODIMENTS

The present invention provides systems and methods of discouraging fraud arising from the duplication of postal indicia used to send mailpieces through the mail by incorporating a copy detection pattern (CDP) having both static portions and dynamic portions into a postal indicium to enable identification of fraudulent duplicates of the postal indicium.

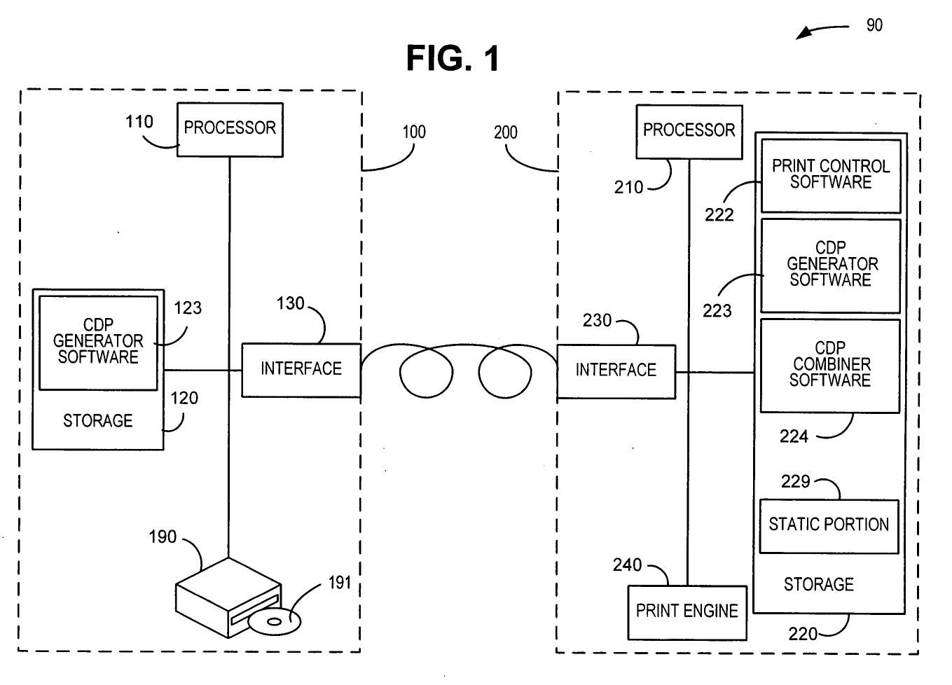

FIG. 1 depicts a pair of devices 90 that includes an electronic device 100 and a printing device 200 that can be used to print postal indicium having a CDP according to an embodiment of the invention. The electronic device 100 may be any of a variety of forms of computer system, including without limitation, a personal workstation or server. The printing device 200 may be any of a variety of forms of printing device incorporating a print engine 240 to print postal indicia onto either mailpieces or onto labels to be affixed to mailpieces, including without limitation, a laser print engine, an inkjet print engine, a thermal print engine and/or dot-matrix impact print engine.

Electronic device 100 incorporates a processor 110 connected to a storage 120 and an interface 130. The processor 110 accesses the storage 120 to retrieve and execute sequences of instructions that make up software, such as a CDP generator software 123. The interface 130 provides an interface by which the electronic device 100 may be attached to the printing device 200. The printing device 200 incorporates a processor 210 connected to a storage 220, an interface 230 and the print engine 240. The processor 210 accesses the storage 220 to retrieve and execute sequences of instructions that make up software, such as a print control software 222, CDP generator software 223 and a CDP combiner software 224. The interface 230 provides an interface by which the electronic device 200 may be attached to the electronic device 100.

As those skilled in the art will readily recognize, the processors 110 and 210 may be of any of a wide variety of processing devices, including and without limitation, microcontrollers, microprocessors, sequencers, digital signal processors or state machines implemented in hardware logic. In some embodiments, one or both of the processors 110 and 210 may be any of a number of commercially available processors executing at least a portion of the widely known and used “X86” instruction set. Furthermore, the storages 120 and 220 may be of any of a wide variety of types of storage devices, including and without limitation, disk drives (e.g. and without limitation, hard drives, floppy drives, magneto-optical drives, magnetic tape drives or CD-ROM drives), solid state memory (e.g. and without limitation, static RAM, dynamic RAM, ROM, EEPROM or FLASH) and memory card readers. As previously discussed, the interfaces 130 and 230 allow the electronic device 100 and the printing device 200 to be attached to each other. This attachment may be through a direct electrical or optical connection, such as a digital parallel or digital serial interface (e.g., RS-232C, Universal Serial Bus, IEEE-1394), or through a network (e.g., Ethernet).

Furthermore, the electronic device 100 may also incorporate a media storage device 190 capable of interacting with a storage medium 191 (which may or may not be a form of removable media) to store and/or retrieve software and/or data. Alternatively, the media storage device 190 may be incorporated into the printing device 200. The software and/or data may include software stored in either storages 120 or 220, including without limitation, the CDP generator software 123, the print control software 222, the CDP generator software 223, and/or the CDP combiner software 224.

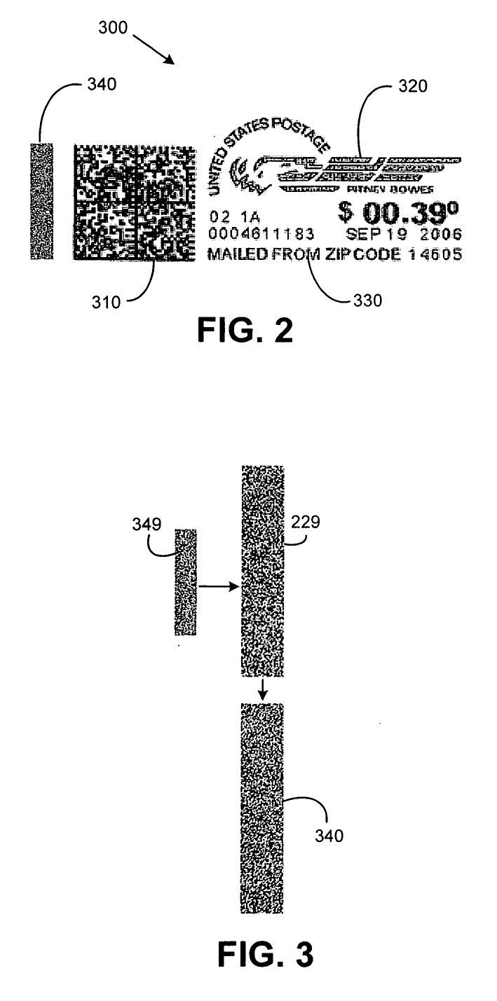

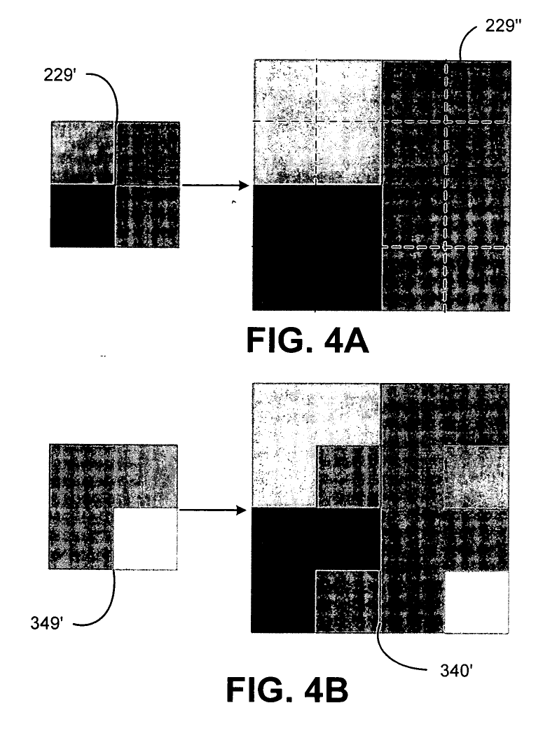

FIG. 2 depicts an exemplary postal indicium 300 created and printed by the pair of devices 90 in a manner that will shortly be explained. Incorporated into the indicium 300 is optionally one or more of a two-dimensional barcode 310, an image 320, and human readable text 330. Also incorporated into the indicium 300 is a CDP 340. The barcode 310, which may be generated by either the printing device 200 or electronic device 100 or combination of the two, encodes various pieces of information regarding the indicium 300 in which the barcode 310 will be used and/or a mailpiece (not shown) to which the indicium 300 in which the barcode will be used is to be affixed. Such information can include, for example and without limitation, the amount of the postage represented by the indicium 300, the date on which the barcode 310 was generated, data concerning a characteristic and/or unique identifier of the printing device 200, an identifier of the sender and/or intended recipient, data concerning the location of the sender and/or intended recipient, an identifier that is assigned and is unique to each mailpiece, the weight of the mailpiece, and/or data concerning the size of the mailpiece. The image 320 may be any conceivable image, including for example and without limitation, a company logo, a picture and/or a drawing. The human readable text 330 provides in text form various pieces of information regarding the indicium 300 and/or the mailpiece to which the indicium 300 is to be affixed, including for example and without limitation, the amount of postage represented by the indicium 300, the date on which the indicium 300 was printed, an identifier of the sender and/or the intended recipient, and/or data concerning the location of the sender and/or the intended recipient. Not unlike barcode 310, the CDP 340 encodes various pieces of information regarding the indicium 300 and/or a mailpiece (not shown) to which the indicium 300 is to be affixed, including for example and without limitation, the amount of the postage represented by the indicium 300, the date on which the indicium 300 was generated, data concerning a characteristic and/or unique identifier of the printing device 200, an identifier of the sender and/or intended recipient, data concerning the location of the sender and/or intended recipient, an identifier that is assigned and is unique to each mailpiece, the weight of the mailpiece, and/or data concerning the size of the mailpiece. As is depicted in FIG. 3, and as will be explained, the CDP 340 is created by combining one or more static portions 229 stored in the storage 220 with one or more dynamic portions 349.

In executing a sequence of instructions of the CDP generator software 123, the processor 110 performs tasks associated with the printing of the indicium 300 by generating a static portion of the CDP 340, using at least one piece of information about the printing device 200, the indicium 300 and/or the mailpiece with which the postal indicium 300 is used that is expected to change relatively infrequently (if at all) between printings of postal indicia by the printing device 200. Such a piece of static information may be, for example, a unique identifier of the printing device 200. Such static information could also be, for example, an identifier of a sender, or data concerning the location of the sender. Such a piece of static information may also be at least a portion of the barcode 310 that is expected to change relatively infrequently, and this may be done to gain the benefit of the manner in which data is encoded by the barcode 310, including a form of encryption that may be used in generating the barcode 310. At least some of these pieces of information may be stored in storages 120 and/or 220.

Regardless of what pieces of information are used in generating the static portion of the CDP 340, and regardless of where that information is stored, considerable processing capability and storage capacity are required to execute the generation of the static portion just described. By employing the processor 110 of the electronic device 100 to carry out this processing, the processor 210 may be allowed to be a lower cost processor of lesser capability than the processor 110, and the storage 220 may be allowed to be of a smaller capacity than the storage 120.

After the static portion of the CDP 340 has been created, the processor 110 is caused to operate the interface 130 to transmit the static portion of the CDP 340 to the printing device 200, where the processor 210 receives the prepared form of the static portion through the interface 230 and stores it as the static portion 229 in the storage 220. Alternatively, the generation of the static portion may be performed when the printing device 200 is being manufactured and stored in the storage 220 during manufacture of the printing device 200, or may be performed upon initialization of the printing device 200 and stored in the storage 220 during such initialization.

At a time after receipt and storage of the static portion 229, a request by a user of the printing device 200 to print a postal indicium 300 executes the print control software 222 by the processor 210, which causes the processor 210 to create the CDP 340 and then incorporate the CDP 340 into the postal indicium 300. The processor 210, in executing a sequence of instructions of the CDP generator software 223, prepares for the printing of the postal indicium 300 by generating a dynamic portion 349 (FIG. 3) of the CDP 340, using at least one piece of information about the indicium 300 and/or the mailpiece with which the postal indicium 300 is used that is expected to change relative frequently, perhaps with each printing of a postal indicium. Such a piece of dynamic information may be the time of when the postal indicium 300 is generated, the weight of the mailpiece, the amount of the postage, or an identifier of the receiver. Such a piece of dynamic information may also be at least a portion of the barcode 310 that is expected to change relatively frequently, and this may be done to gain the benefit of the manner in which data is encoded by the barcode 310, including a form of encryption that may be used in generating the barcode 310. At least some of these pieces of information may be stored in storages 120 and/or 220.

After generating the dynamic portion 349 of the CDP 340, the processor 210, in executing a sequence of instructions of the CDP combiner software 224, further prepares for the printing of the postal indicium 300 by retrieving the static portion 229 from the storage 220 and combining the dynamic portion 349 with the static portion 229 to create the CDP 340 as illustrated in FIG. 3. FIGS. 4A and 4B depict aspects of one approach to carrying out such a combining. Each pixel of static portion 229 is first transformed, such as for example, by doubling in each dimension (vertical and horizontal), such that each pixel of static portion 229 is replaced with four pixels of the same color and/or gray shade level. This transformation is more clearly shown in FIG. 4A, where a cluster 229′ consisting of four adjacent pixels of the static portion 229 is replaced with a cluster 229″ consisting of sixteen adjacent pixels formed by doubling in each dimension each pixel of the cluster 229′. Thus, for example, if the static portion 229 is generated as a 30×150 pixel image, such doubling would result in a new image that is 60×300 pixels. The dynamic portion 349 can then be integrated into the doubled static portion 229, or predefined portions thereof, using a predefined integration function. For example, if the dynamic portion 349 is generated as a 30×150 pixel image, each pixel of the dynamic portion 349 can replace one pixel in each one of the transformed pixels of the static portion 229, thereby creating the CDP 340 that combines both static and dynamic portions. An example of the replacement of one pixel in each of the 2×2 portions of the cluster 229″ is more clearly shown in FIG. 4B where each pixel of a cluster 349′ of pixels of the dynamic portion 349 replaces one of the four pixels of each 2×2 cluster from cluster 229″ (as depicted, it is the lower right pixel of each 2×2 cluster that is replaced). The predefined integration function can be changed based on predetermined parameters to add further security to the CDP 340. Such parameters could include, for example and without limitation, the date, the postage amount, the zip code, etc.

Further execution of a sequence of instructions of the print control software 222 by the processor 210 causes the processor 210 to create the postal indicium 300, such as, for example, by assembling all of the parts of the postal indicium 300 into a printable image, and operate the print engine 240 to print the postal indicium 300, incorporating the CDP 340. The postal indicium 300 may be printed either onto an envelope or other packaging of a mailpiece, directly, or onto a sticker or other adhesive label to be subsequently affixed to the mailpiece.

As those skilled in the art will readily recognize, numerous different algorithms may be employed in the generation of the static portion 229 and the dynamic portion 349 of the CDP 340. More particularly, various random or pseudo-random algorithms for creating apparently random gray levels and/or colors may be employed to create the static portion 229 and the dynamic portion 349 in which chosen static and dynamic pieces of data may serve as seed values and/or other as other inputs. In anticipation of the combining of the static portion 229 with the dynamic portion 349, one or more techniques may be employed to adjust the gray scale of one or both of the static portion 229 and the dynamic portion 349 to cause the gray scales of both to be substantially similar.

Similarly, as those skilled in the art will readily recognize, numerous different algorithms may be employed in combining the static portion 229 and the dynamic portion 349 to create the CDP 340. Although an approach of replacing pixels of one of either the static portion 229 or the dynamic portion 349 with pixels of the other may be used, other approaches including, for example and without limitation, the averaging or interspersing of pixels from both portions, may be employed.

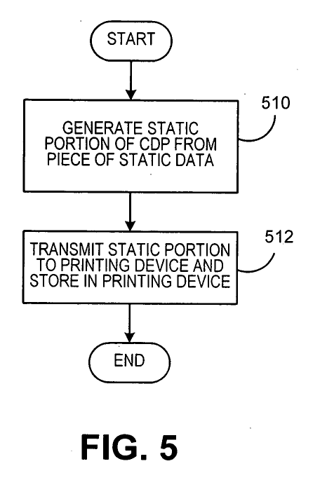

FIG. 5 is a flowchart illustrating the generation and storage of a static portion of a CDP. At 510, a static portion of a CDP to be incorporated into a postal indicium is created from at least one piece of static data. Any of a variety of algorithms may be employed to create the static portion, including without limitation, random and pseudo-random algorithms for the generation of gray levels for monochrome or color pixels employing the at least one piece of static data as a seed or other input. Furthermore, the at least one piece of static data includes a piece of data that is not expected to change frequently (if at all) between printings of postal indicia. At 512, the static portion is transmitted to a printing device (such as the printing device 200 discussed earlier) that will be used to print the postal indicium to enable the printing device to combine the static portion with a dynamic portion and to print the combination of the two portions as a CDP and stored in the printing device. As noted above, the static portion is may be generated by a device other than the printing device to minimize the processing power and speed requirements of the printing device. Alternatively, the generation of the static portion could also be performed by the printing device upon initialization of the printing device. Since the static portion need only be generated one time (and not each time an indicium is generated), the processing power and speed of such generation is not critical, and therefore a lower cost processor can still be used. In this situation, in 512 the static portion need not be transmitted to the printing device, but need only be stored by the printing device (such as printing device 200 discussed earlier).

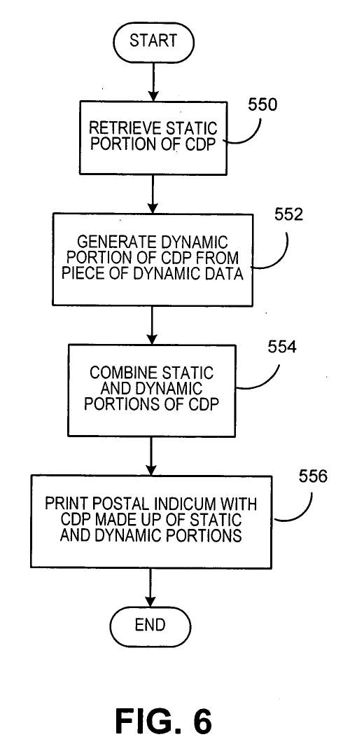

FIG. 6 is a flowchart of an embodiment of the creation and printing of a postal indicium, that incorporates a CDP generated according to embodiments of the present invention, to be printed by a printing device. At 550, a printing device, such as the printing device 200, retrieves the static portion of the CDP from a storage device therein, such as the storage 220. As noted above, the static portion may have been generated by another device, e.g., electronic device 100, or by the printing device. The storing of the static portion may have occurred during manufacturing of the printing device, upon initialization of the printing device, or at any other time.

At 552, the printing device creates a dynamic portion of the CDP from at least one piece of dynamic data. Any of a variety of algorithms may be employed to create the dynamic portion, including without limitation, random and pseudo-random algorithms for the generation of gray levels for monochrome or color pixels employing the at least one piece of dynamic data as a seed or other input. Furthermore, the at least one piece of dynamic data includes a piece of data that is expected to change frequently, perhaps with every printing of postal indicia, such as, for example, the time of generation of the dynamic portion.

At 554, the printing device combines the static and dynamic portions to create the CDP that will be incorporated into the postal indicium to be printed by the printing device. Any of a variety of algorithms may be employed to combine the static and dynamic portions, including without limitation, replacement of pixels of one portion by another, averaging of pixel gray levels, and interspersing pixels of both patterns. Furthermore, the gray levels of one or both patterns may be adjusted to achieve a substantially similar range of gray levels between the two patterns. At 556, the postal indicium is prepared and printed, wherein the postal indicium incorporates at least the CDP created at 554 from combining the static and dynamic portions. The postal indicium may also incorporate an image, human-readable text and/or a barcode. Since the postal indicium includes a copy detection pattern that is generated from static and dynamic portions, the possibility of fraudulently using the postal indicium by copying the postal indicium and re-using it is significantly reduced (if not eliminated completely), as known verification techniques for copy detection patterns can be utilized to determine whether or not an indicium is a copy or an original indicium. Such verification techniques are described, for example, in co-pending application Ser. No. 11/240,889, filed Sep. 30, 2005.

By utilizing the combination of the printing device 200 and electronic device 100 as described above to generate the CDP 340, greater flexibility is provided in the determining the amount of data to be transmitted from the electronic device 100 to the printing device 200, the amount of data to be stored in the printing device 200, and the amount of data to be generated in the printing device 200. Accordingly, this allows combined optimization of (i) the cost of the printing device 200 by limiting the processing requirements and memory requirements, (ii) the processing time required for generating and printing indicia, and (iii) transmission time of data between the electronic device 100 and printing device 200.

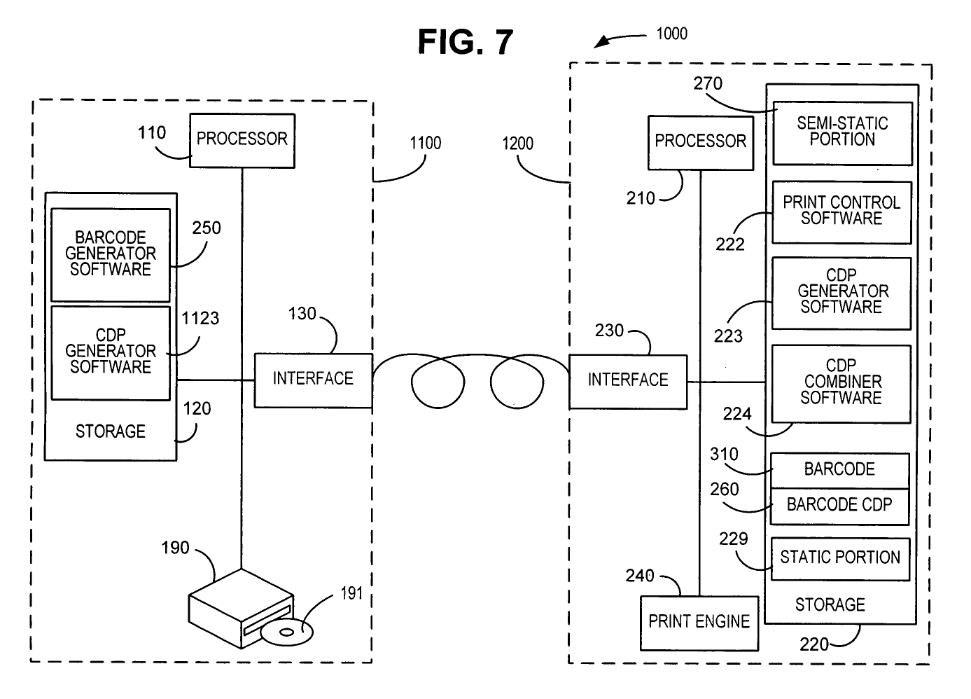

FIG. 7 depicts a pair of devices 1000 that includes an electronic device 1100 and a printing device 1200 that can be used to print postal indicia having a CDP according to another embodiment of the present invention. In this embodiment, the electronic device 1100 is used to generate the two-dimensional barcode 310 included in each indicium and download the generated barcode to the printing device 1200. Preferably, the electronic device 1100 will pre-compute a plurality of barcodes for storage in the printing device 1200, thereby removing the necessity for the printing device 1200 to be in communication with the electronic device 1100 when a postal indicium will be printed. Instead, the printing device 1200 can generate a complete postal indicium, using the barcodes generated by the electronic device 1100 and stored in the printing device 1200. Only when the supply of pre-computed barcodes stored in the printing device 1200 is depleted will the printing device 1200 need to communicate with the electronic device 1100 to replace the supply of pre-computed barcodes. Referring now to FIG. 7, electronic device 1100 is similar to electronic device 100 as described with respect to FIG. 1, and also includes barcode generator software 250 that is utilized to generate the two-dimensional barcode 310 described with respect to FIG. 2. Additionally, the electronic device 1100 includes CDP generator software 1123, which is similar to CDP generator software 123 previously described and also includes additional functionality to generate a Barcode CDP for each barcode generated by the electronic device 1100 as described below. The printing device 1200 is similar to printing device 200 described with respect to FIG. 1, and the storage 220 stores additional information including one or more barcode and Barcode CDP portion 260 and a semi-static portion 270 as described below.

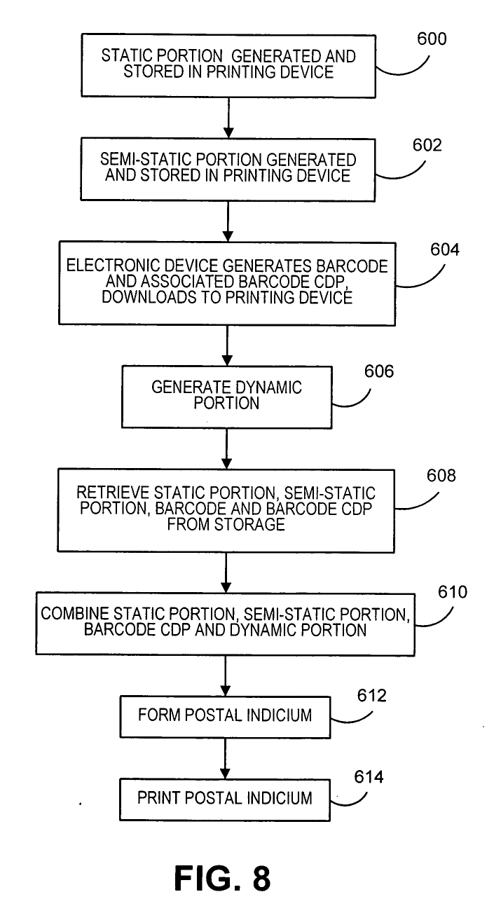

The operation of the pair of devices 1000 illustrated in FIG. 7 will be described with respect to the flow chart illustrated in FIG. 8. At 600, a static portion 229 for use in generating a CDP to be incorporated into a postal indicium is created from at least one piece of static data and stored in the printing device 1200 similarly as described above. Such static data could include, for example, a unique identifier of the printing device 1200. The static portion 229 may be generated by the electronic device 1100 using CDP generator software 1123 and transmitted to the printing device 1200 using the interfaces 130, 230. Alternatively, the static portion 229 may be generated by the printing device 1200 using CDP generator software 223, or may be generated and stored during the manufacturing process of the printing device 1200. Preferably, the static portion 229 does not change during the use of the printing device 1200.

At 602, the printing device 1200 generates a semi-static portion 270 for use in generating a CDP and stores the semi-static portion 270 in the storage 220. The semi-static portion 270 encodes information that does not change with each indicium printed by the printing device 1200, but will change at some point during the use of the printing device 1200. Such semi-static information could include, for example, the date, provided by a clock (not shown), and therefore the semi-static portion 270 will change each day. Using the date as the semi-static information requires that a new semi-static portion 270 be generated only once each day. Therefore, the time required for processing is not critical and such processing can be performed by the processor 210 upon powering of the printing device 1200 for the first time each day (or when the clock changes to a new day if the printing device 1200 is powered all the time). Additionally, using the processor 210 to generate the semi-static portion 270, instead of the processor 110 of the electronic device 1100, removes the necessity for the printing device 1200 to communicate with the electronic device 1100 each day. It should be understood, of course, that using a semi-static portion 270 is optional, and need not be required.

At 604, the electronic device 1100 generates one or more barcodes 310 to be used in indicia, utilizing the barcode generator software 250, and generates an associated barcode CDP 260 for each barcode 310 utilizing the CDP generator software 1123. The barcodes 310 and associated barcode CDPs 260 are downloaded to the printing device 1200 for storage in the storage 220. Each barcode 310 encodes various pieces of information regarding the indicium 300 in which the barcode 310 will be used, such as, for example, the amount of postage represented by the indicium in which the barcode 310 will be used, the date on which the barcode 310 was generated, data identifying the printing device 1200 for which the barcode 310 was generated, and the like. The barcode CDP 260 also encodes various pieces of information regarding the barcode 310 with which it is associated. Such generation and downloading could be initiated by a communication from the printing device 1200 requesting such generation and downloading. Preferably, the printing device 1200 stores a plurality of barcodes 310, such that the printing device 1200 can print a plurality of indicia before having to communicate with the electronic device 1100 to receive additional barcodes 310. The barcodes 310 may represent different amounts of postage, allowing a user to select the value for an indicium. It should be understood that the generation and downloading of barcodes 310 and associated barcode CDP 260 can occur at any time and need not be performed if sufficient quantities (which may be one or more) of barcodes 310 and associated barcode CDPs 260 are available for use in the storage 220 of printing device 1200.

A request by a user of the printing device 1200 to generate and print a postal indicium 300 executes the print control software 222 by the processor 210, which causes the processor 210 to create a CDP 340 and then incorporate the CDP 340 into a postal indicium 300. More specifically, the processor 210, in executing a sequence of instructions of the CDP generator software 223, prepares for the printing of the postal indicium 300 by generating a dynamic portion 349, at 606, to be used in generating the CDP 340, using at least one piece of information about the indicium 300 and/or the mailpiece with which the postal indicium 300 is used that is expected to change relative frequently, perhaps with each printing of a postal indicia. Such a piece of dynamic information may be, for example, the time when the postal indicium 300 is generated. At 608, the processor 210 retrieves the static portion 229, the semi-static portion 270, and a barcode 310 and its associated barcode CDP 260 from the storage 220 for use in generating the CDP 340. It should be understood that such retrieval in 608 may occur concurrently with, before or after generation of the dynamic portion 349 in 606.

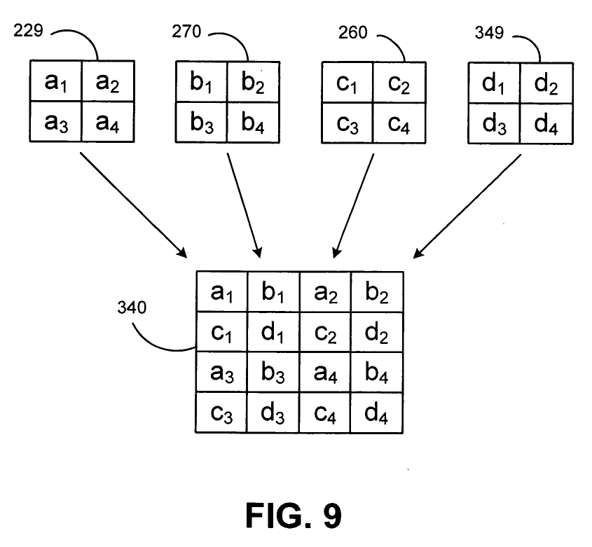

In 610, the processor 210, in executing a sequence of instructions of the CDP combiner software 224, combines the static portion 229, the semi-static portion 270, the barcode CDP 260, and the dynamic portion 349 to create the CDP 340. Any of a variety of algorithms may be employed to combine the multiple portions, including without limitation, interspersing pixels of all patterns in a predefined pattern. Furthermore, the gray levels of one or both patterns may be adjusted to achieve a substantially similar range of gray levels between the patterns. FIG. 9 depicts aspects of one approach to carrying out such a combination. FIG. 9 illustrates 2×2 portions of each of the static portion 229, semi-static portion 270, barcode CDP 260 and dynamic portion 349 that are to be combined. The static portion 229 consists of pixels a₁, a₂, a₃ and a₄; the semi-static portion 270 consists of pixels b₁, b₂, b₃ and b₄; the barcode CDP portion consists of pixels c₁, c₂, c₃ and c₄; and the dynamic portion 349 consists of pixels d₁, d₂, d₃ and d₄. If each of the static portion 229, semi-static portion 270, barcode CDP portion 260 and dynamic portion 349 are generated as a 30×150 pixel image, the CDP 340 can be generated as a 60×300 pixel image by forming 2×2 portions that include the respective pixel data from each of the static portion 229, semi-static portion 270, barcode CDP portion 260 and dynamic portion 349. Thus for example, a first 2×2 portion of the CDP 340 would include pixels a₁, b₁, c₁, d₁, a second 2×2 portion would include pixels a₂, b₂, c₂, d₂, and so on as shown in FIG. 9.

At 612, the processor 210 forms a postal indicium 300 using the CDP 340 generated at 610, the barcode 310 associated with the barcode CDP 260 used to generate the CDP 340, and any other information or images included in the postal indicium 300. At 614, the postal indicium 300 is printed by the printing device 1200. Since the postal indicium 300 printed by the printing device 1200 includes a CDP 340 that is generated from static and dynamic portions, the possibility of fraudulently using the postal indicium 300 by copying the postal indicium 300 and re-using it is significantly reduced (if not eliminated completely), as known verification techniques for copy detection patterns can be utilized to determine whether or not an indicium is a copy or an original indicium.

While preferred embodiments of the invention have been described and illustrated above, it should be understood that these are exemplary of the invention and are not to be considered as limiting. Those skilled in the art will also recognize that various modifications can be made without departing from the spirit of the present invention. Accordingly, the invention is not to be considered as limited by the foregoing description but is only limited by the scope of the appended claims and their equivalents.

The invention claimed is:

1. A method of creating and printing an indicium incorporating a copy detection pattern having one or more static portions and one or more dynamic portions, the method comprising:
retrieving at least one static portion of a copy detection pattern that is stored in a storage of a printing device;
generating at least one dynamic portion in the printing device;
combining the at least one static portion and the at least one dynamic portions in the printing device to create the copy detection pattern;
preparing an indicium that includes the copy detection pattern; and
printing the indicium.

2. The method according to claim 1, wherein the copy detection pattern further includes a semi-static portion and a barcode portion, the barcode portion being associated with a barcode used in the indicium, the method further comprising:
retrieving the semi-static portion from the storage of the printing device, the semi-static portion being previously generated; and
retrieving the barcode portion and the associated barcode from the storage of the printing device, the barcode portion and associated barcode being previously generated and stored in the printing device.

3. The method according to claim 2, wherein the barcode portion and associated barcode are generated by a device other than the printing device and downloaded to the printing device.

4. The method according to claim 2, wherein combining the static portion and the dynamic portion further comprises:
combining the static portion, the semi-static portion, the dynamic portion and the barcode portion in the printing device to create the copy detection pattern.

5. The method according to claim 4, wherein combining the static portion, the semi-static portion, the dynamic portion and the barcode portion further comprises:
interspersing pixels of the static portion, the semi-static portion, the dynamic portion and the barcode portion.

6. The method according to claim 2, wherein the semi-static portion is generated based on a date.

7. The method according to claim 1, wherein the static portion is generated based on a unique identification of the printing device.

8. The method according to claim 1, wherein the dynamic portion is generated from at least one piece of information that may change each time the printing device prints an indicium.

9. The method according to claim 8, wherein the at least one piece of information is a time when the dynamic portion is generated.

10. The method according to claim 8, wherein the at least one piece of information is a portion of a barcode of the indicium.

11. The method according to claim 1, wherein combining the static portion and dynamic portion further comprises interspersing pixels of the static portion with pixels of the dynamic portion.

12. A printing device to print an indicium incorporating a copy detection pattern having one or more static portions and one or more dynamic portions, comprising:
a print engine;
a storage having stored therein copy detection pattern generator software; and
a processor structured to:
store at least one static portion in the storage;
generate at least one dynamic portion;
combine the at least one static portion and the at least one dynamic portion to create the copy detection pattern; and
print the indicium.

13. The printing device according to claim 12, further comprising an interface and wherein the processor is further structured to receive the static portion through the interface from another electronic device on which the static portion was generated.

14. The printing device according to claim 12, wherein the static portion is generated from at least an identifier unique to the printing device.

15. The printing device according to claim 12, wherein the processor is further structured to generate the dynamic portion from at least one piece of information that may change each time the printing device prints an indicium.

16. The printing device according to claim 15, wherein the at least one piece of information is a time when an indicium is generated by the printing device.

17. The printing device according to claim 12, wherein the processor is further structured to combine the static portion and the dynamic portion by interspersing the pixels of the static portion with the pixels of the dynamic portion.

18. A machine-readable medium on which a sequence of instructions are stored that when executed by a processor of a printing device causes the processor to perform operations comprising:
retrieving a static portion of a copy detection pattern from a storage of the printing device, the static portion being previously generated and stored in the printing device;
generating a dynamic portion of the copy detection pattern in the printing device;
combining the static portion and the dynamic portion in the printing device to create the copy detection pattern;
preparing an indicium that includes the copy detection pattern; and
printing the indicium.

19. The machine-readable medium according to claim 18, wherein the operations further comprise generating the dynamic portion from at least one piece of information that may change each time an indicium is printed by the printing device.

20. The machine-readable medium according to claim 19, wherein the at least one piece of information is a time indicating when an indicium is generated by the printing device.

21. The machine-readable medium according to claim 18, wherein combining the static portion and the dynamic portion further comprises interspersing pixels of the static portion with pixels of the dynamic portion.

22. The method of claim 1, wherein the indicium is a postal indicium.

23. The printing device of claim 12, wherein the indicium is a postal indicium.

24. The machine readable medium of claim 18, wherein the indicium is a postal indicium.
